(19) United States
(12) Patent Application Publication
(10) Pub. No.: US 2025/0372603 A1
(43) Pub. Date: Dec. 4, 2025

(54) ELECTRODE SHEET MANUFACTURING APPARATUS AND ELECTRODE SHEET MANUFACTURING METHOD

(71) Applicants: Prime Planet Energy & Solutions, Inc., Tokyo (JP); TOYOTA JIDOSHA KABUSHIKI KAISHA, Aichi-ken (JP)

(72) Inventors: Yuuki TOYOSHIMA, Himeji-shi (JP); Hiroyoshi YAMAMOTO, Himeji-shi (JP); Shinji YOSHIOKA, Himeji-shi (JP); Toshiatsu ODAI, Himeji-shi (JP); Tetsumasa MARUO, Ibaraki-shi (JP); Daichi UMINO, Himeji-shi (JP); Kengo HAGA, Nagoya-shi (JP); Tomofumi HIRUKAWA, Toyota-shi (JP); Yuki MASUDA, Kariya-shi (JP)

(21) Appl. No.: 19/215,333

(22) Filed: May 22, 2025

(30) Foreign Application Priority Data
May 28, 2024 (JP) 2024-086694

(51) Int. Cl. H01M 4/04; H01M 4/66; H01M 4/75

(52) U.S. Cl. CPC H01M 4/0435; H01M 4/0404; H01M 4/661; H01M 4/75

(57) ABSTRACT

An electrode sheet manufacturing method includes a stepped roll pressing step of conveying an electrode sheet while pressing the electrode sheet onto a stepped roll that has a larger diameter at a part coming into contact with a boundary region of an uncoated portion with an active material layer than other parts coming into contact with other regions of the electrode sheet.

### CROSS REFERENCE TO RELATED APPLICATIONS

The present application claims priority from Japanese Patent Application No. 2024-086694 filed on May 28, 2024, which is incorporated by reference herein in its entirety.

### BACKGROUND

The present invention relates to an electrode sheet manufacturing apparatus and a method of manufacturing an electrode sheet.

JP 2023-036089 A discloses a method of manufacturing an electrode sheet including a coated portion, in which an active material layer containing an electrode material is coated on a metal foil, and an uncoated portion defined at an end portion of the coated portion. The manufacturing method disclosed in the publication discloses that the uncoated portion is pressed by a pair of elastic rolls when roll-pressing the electrode sheet. By pressing the uncoated portion using the pair of elastic rolls, compressive force and deformation force can be applied to the same location in the uncoated portion. It is stated that this allows the uncoated portion to be stretched while preventing breakage of the uncoated portion.

### SUMMARY

The present inventors found that there is an event that wrinkles may occur in the electrode sheet even though the uncoated portion is pressed with a pair of elastic rolls when roll-pressing the electrode sheet.

According to the present disclosure, an electrode sheet manufacturing apparatus is provided that manufactures an electrode sheet, which includes a current collector made of an oblong metal foil, an unformed portion defined along a longitudinal axis of the current collector at a predetermined widthwise position in the current collector, and an active material layer formed on a portion of the current collector other than the unformed portion. The electrode sheet manufacturing apparatus includes a roll-press unit that roll-presses the electrode sheet. The roll-press unit includes a conveyor device conveying the electrode sheet along a predetermined conveyance passage, and a stepped roll pressing device disposed in the conveyance passage and pressing an stepped roll onto the electrode sheet. The stepped roll has a larger diameter locally at a part coming contact with a boundary region of the unformed portion with the active material layer than other parts of the stepped roll coming into contact with other regions of the electrode sheet.

Such an electrode sheet manufacturing apparatus is able to reduce wrinkles of the electrode sheet that result from the difference in elongation rate of the current collector between the boundary region of the unformed portion with the active material layer and other regions of the unformed portion.

An electrode sheet manufacturing method according to the present disclosure relates to a method of manufacturing an electrode sheet that includes a current collector made of a long metal foil, an unformed portion defined along a longitudinal axis of the current collector at a predetermined widthwise position in the current collector, and an active material layer formed on a portion of the current collector other than the unformed portion. The method includes a stepped roll pressing step of conveying the electrode sheet while pressing the electrode sheet with a stepped roll having a larger diameter locally at a part coming into contact with a boundary region of the unformed portion with the active material layer than other parts of the stepped roll coming into contact with other regions of the electrode sheet.

Such a electrode sheet manufacturing method is able to provide an electrode sheet that reduces wrinkles resulting from the difference in elongation rate of the current collector between the boundary region and other regions of the unformed portion.

### BRIEF DESCRIPTION OF THE DRAWINGS

FIG. 1 is a manufacturing flowchart illustrating an electrode sheet manufacturing method.

FIG. 2 is a schematic view of an electrode sheet 10.

FIG. 3 is a schematic view illustrating another embodiment the electrode sheet 10.

FIG. 4 is a schematic view illustrating an example of a roll-pressing step S6 proposed herein.

FIG. 5 is a schematic view illustrating a first pressing step S6a.

FIG. 6 is a schematic view illustrating a stepped roll pressing step S6c.

FIG. 7 is a schematic view illustrating another embodiment of the electrode sheet manufacturing method.

FIG. 8 is a schematic view illustrating another embodiment of the manufacturing method of an electrode sheet 10.

FIG. 9 is a schematic view illustrating a stepped roll 50A.

### DETAILED DESCRIPTION

Hereinbelow, embodiments of the technology according to the present disclosure will be described with reference to the drawings. It should be noted, however, that the embodiments disclosed herein are, of course, not intended to limit the invention. The drawings are depicted schematically and do not necessarily accurately depict actual objects. The features and components that exhibit the same effects are designated by the same reference symbols as appropriate, and the description thereof will not be repeated as appropriate. Unless specifically stated otherwise, the recitation of numerical ranges in the present description, such as “X to Y”, is meant to include any values between the upper limits and the lower limits, inclusive, that is, “greater than or equal to X to less than or equal to Y”.

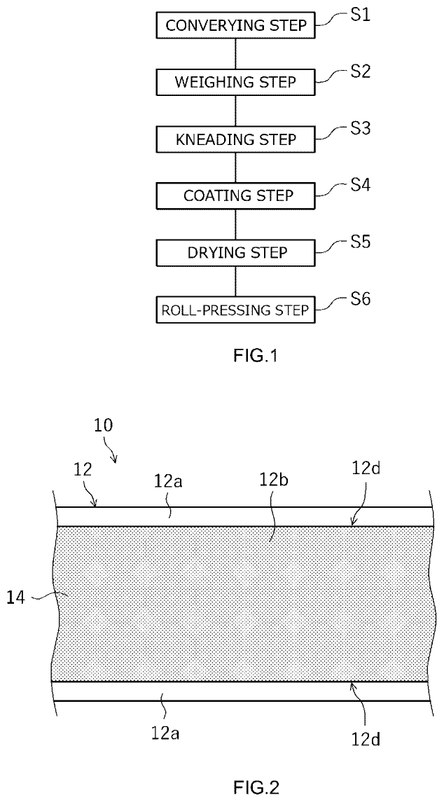

FIG. 1 is a manufacturing flowchart illustrating a method of manufacturing an electrode sheet. As illustrated in FIG. 1, the electrode sheet manufacturing method includes a conveying step S1, a measuring step S2, a kneading step S3, a coating step S4, a drying step S5, and a roll-pressing step S6. However, the electrode sheet manufacturing method may include other steps.

### Electrode Sheet 10

FIG. 2 is a schematic view of an electrode sheet 10. The electrode sheet 10 constitutes a positive electrode sheet or a negative electrode sheet of an electrode assembly that is to be accommodated in the inside of the electricity storage device. The term “electricity storage device” refers to a repeatedly chargeable device, and it is intended to encompass what is called storage batteries (chemical cells), such as lithium-ion secondary batteries, nickel-metal hydride batteries, and nickel-cadmium batteries, as well as capacitors (i.e., physical cells) such as electric double-layer capacitors.

As illustrated in FIG. 2, the electrode sheet 10 includes a current collector 12 and an active material layer 14. The current collector 12 is a member that is made of a metal foil. The current collector 12 is an oblong strip-shaped metal member. For the current collector 12, it is possible to use a metal material that has required electrical conductivity. For positive electrode current collector foil, it is possible to use, for example, aluminum, aluminum alloys, or the like. For negative electrode current collector foil, it is possible to use, for example, copper, copper alloys, or the like. The active material layer 14 is coated on a predetermined position within the current collector 12. The active material layer 14 is formed on at least one surface of the strip-shaped current collector 12. In this embodiment, the active material layer 14 is formed on both surfaces of the current collector 12. The active material layer 14 is a layer containing an electrode active material. For positive electrode active material, it is possible to use, for example, lithium-transition metal composite oxides. For negative electrode active material, it is possible to use, for example, carbon materials, silicon based materials, and composite oxides thereof. The active material layer may also contain additive agents other than the electrode active material, such as binders and conductive agents.

The electrode sheet 10 is formed by coating an electrode mixture slurry, which forms the active material layer 14, onto the current collector 12, and drying. The current collector 12 is provided with uncoated portions 12a (i.e., unformed portions) and a coated portion 12b. The uncoated portions 12a are portions of the current collector 12 on which the active material layer 14 is not coated. The uncoated portions 12a are defined along a longitudinal axis of the electrode sheet 10 in widthwise end portions of the electrode sheet 10. In this embodiment, the uncoated portions 12a are defined at both widthwise ends of the electrode sheet 10. The coated portion 12b is disposed between the uncoated portions 12a at both ends of the electrode sheet 10. The electrode mixture slurry is coated onto the coated portion 12b. As a result, the active material layer 14 is formed on the coated portion 12b of the current collector 12. That is, the active material layer 14 is disposed between the uncoated portions 12a at both widthwise ends of the electrode sheet 10. Thus, the electrode sheet may include the current collector 12 made of an oblong metal foil, unformed portions (uncoated portions 12a herein) defined along the longitudinal axis of the current collector 12 at predetermined widthwise positions in the current collector 12, and the active material layer 14 formed on a portion of the current collector 12 other than the unformed portions.

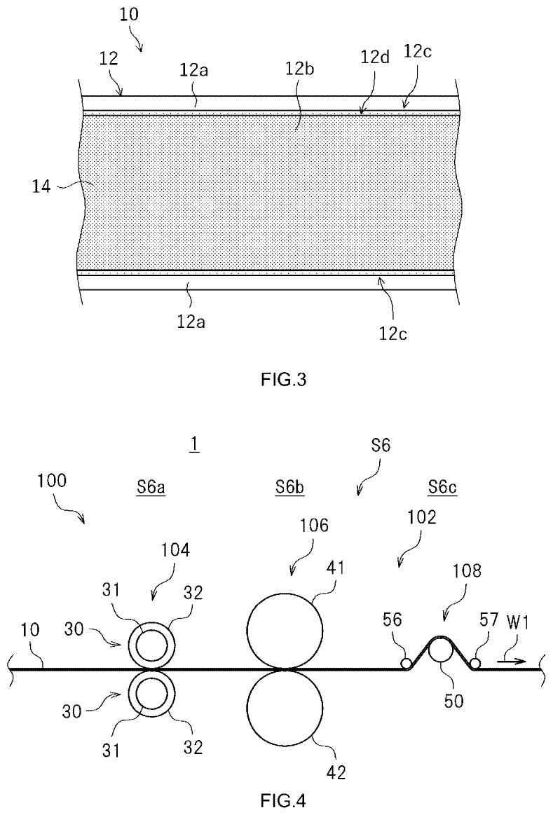

FIG. 3 is a schematic view illustrating another embodiment the electrode sheet 10. As illustrated in FIG. 3, the electrode sheet 10 may be provided with an insulative protective layer 12c at a position in each uncoated portion 12a that is adjacent to the coated portion 12b. Such a structure may be employed in, for example, an electrode sheet 10 used for positive electrode. Providing the protective layer 12c on the electrode sheet 10 used for positive electrode can prevent short circuits between the positive electrode current collector foil and the negative electrode active material layer. Such a protective layer 12c contains an insulative inorganic filler. Examples of the inorganic filler include insulating particles, for example, ceramic particles, such as alumina. The protective layer 12c may contain a binder, for example. The binder may be the same as those illustrated as can be contained in the positive electrode active material layer. In the following, FIGS. 2 and 3 are referred to as appropriate for the constituent components of the electrode sheet 10, even when not specifically stated so.

### Conveying Step S1, Measuring Step S2, Kneading Step S3, Coating Step S4, Drying Step S5

In the conveying step S1 shown in FIG. 1, the electrode sheet 10 is conveyed. The conveying step S1 involves conveying the electrode sheet 10 along a predetermined conveyance passage W1. The measuring step S2 involves weighing source materials for the active material layer 14 (see FIG. 2). The weighing may be implemented with a weighing device (not shown) that includes, for example, a balance scale, a load cell, or the like. The weighed source materials for the active material layer 14 are mixed in the kneading step S3. The kneading step S3 may be implemented by a kneading device (not shown). The source materials for the active material layer 14 that have been made into a slurry state by the kneading device are coated onto the current collector 12 (see FIG. 2) in the coating step S4. The coating step S4 may be implemented by, for example, a coating device (not shown), such as a slit coater, a gravure coater, a die-coater, or a comma coater. The drying step S5 involves drying the slurry-state source materials for the active material layer 14 that have been coated. The drying step S5 may be implemented by, for example, a dryer device (not shown) that generates hot air or emits infrared rays.

### Roll-Pressing Step S6

The roll-pressing step S6 is a step of roll-pressing the electrode sheet 10. Herein, the substrate material for the electrode sheet 10 is a metal foil. The electrode sheet 10 includes a portion on which the active material layer 14 is formed (i.e., coated portion 12b) and a portion on which the active material layer 14 is not formed (i.e., uncoated portion 12a). The roll-pressing step S6 is mainly intended to adjust the active material layer 14 formed by coating to have an appropriate density.

In the roll-pressing step S6, the coated portion 12b is roll-pressed in order to allow the active material layer 14 to have an appropriate density. When the coated portion 12b is roll-pressed, the substrate material, the current collector 12 is stretched in the coated portion 12b. However, in the uncoated portions 12a, the pressing pressure is not directly transmitted to the current collector 12, so the current collector 12 is not easily stretched in the uncoated portions 12a. Accordingly, in the state in which the coated portion 12b alone is pressed, variations in elongation may occur between the coated portion 12b and the uncoated portions 12a. When variations in elongation are large between the coated portion 12b and the uncoated portions 12a, it may be a cause of wrinkles that form in the electrode sheet 10. The uncoated portions 12a are cut into predetermined shapes in a later processing step to form tabs. At that processing step, if wrinkles occur in the boundary regions 12d of the uncoated portions 12a with the active material layer 14, the tabs may not be formed into an appropriate shape.

In order to prevent the wrinkles from forming in the electrode sheet 10, the current collector 12 may be stretched in the uncoated portions 12a before or after roll-pressing the coated portion 12b. One technique of stretching the current collector 12 in the uncoated portions 12a is a technique of pressing the uncoated portions 12a by means of a rubber roll. The technique of pressing the uncoated portions 12a by means of a rubber roll may be referred to as EPS (Elasticity Powered Stretching) as appropriate. The device that presses the uncoated portions 12a by a rubber roll may be referred to as an EPS device as appropriate.

The present inventors found an event in which wrinkles may occur in the electrode sheet 10 even when the uncoated portions 12a are stretched by EPS before or after roll-pressing. The wrinkles occur particularly at the boundary regions 12d of the uncoated portions 12a with the active material layer 14. The present inventors have discovered that such an event is caused because, when stretching the uncoated portions 12a by EPS, the boundary regions 12d of the uncoated portions 12a with the active material layer 14 cannot be stretched appropriately.

That is, the active material layer 14 is formed on the coated portion 12b. The active material layer 14 is a layer containing metal oxide, such as lithium-transition metal composite oxide. Pressing a rubber roll of the EPS onto the active material layer 14 may be a cause of peeling of the active material layer 14. From such a viewpoint, the position of the rubber roll is set in the EPS so that the rubber roll does not come into contact with the coated portion 12b. As a consequence, with EPS, it is difficult to stretch the boundary between the uncoated portions 12a and the coated portion 12b as well as the adjacent areas thereto. In addition, a protective layer containing an inorganic filler is in some cases formed on the boundary between the uncoated portions 12a and the coated portion 12b. In cases where the protective layer is formed, the elongation rate may not match between the area in which the protective layer is formed and the area in which the protective layer is not formed when the rubber roll of EPS is pressed thereon.

As described above, when the uncoated portions 12a are stretched by EPS, it is difficult to appropriately stretch the boundary regions 12d of the uncoated portions 12a with the active material layer 14. As a consequence, the present inventors believe that strain remains in the boundary regions 12d, causing wrinkles in the electrode sheet.

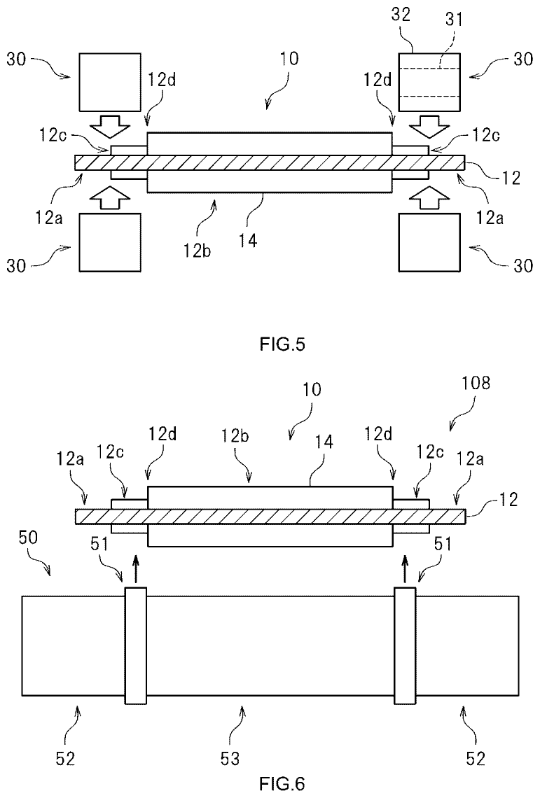

FIG. 4 is a schematic view illustrating an example of the roll-pressing step S6 proposed herein. As illustrated in FIG. 4, the roll-pressing step S6 includes a first pressing step S6a, a second pressing step S6b, and a stepped roll pressing step S6c.

The first pressing step S6a is the above-mentioned EPS, a step of stretching the uncoated portions 12a of the electrode sheet 10. FIG. 5 is a schematic view illustrating the first pressing step S6a. As illustrated in FIG. 5, the first pressing step S6a is a step of press-stretching the uncoated portions 12a of the electrode sheet 10 with a pair of rubber rolls 30 while conveying the electrode sheet 10 along a predetermined conveyance passage.

As illustrated in FIG. 5, the rubber rolls 30 may each be a roll member in which an elastic material 32 is disposed around the outer circumferential surface of a shaft 31. The elastic material 32 used for the rubber rolls 30 may be an elastic material having a required Young's modulus. Examples of the elastic material 32 include resins, such as rubber and urethane. In the first pressing step S6a, the uncoated portions 12a are pressed by the rubber rolls 30, so that the portions that are pushed by the rolls are pressed and stretched by receiving the reaction force of the elastic deformation and compressive deformation from the rubber rolls 30. The first pressing step S6a is able to stretch the uncoated portions 12a without applying a high tension to the electrode sheet 10.

As illustrated in FIG. 4, the second pressing step S6b is a step of roll-pressing the active material layer 14 (coated portion 12b) of the electrode sheet 10. Such a step is a step of adjusting the active material layer 14 (coated portion 12b) to a required density. In the second pressing step S6b, as illustrated in FIG. 4, the electrode sheet 10 is sandwiched by a pair of rolls 41 and 42, and the active material layer 14 is compressed. In this step, the current collector 12, the substrate material, is press-stretched in the portion in which the active material layer 14 is formed (i.e., in the coated portion 12b).

The stepped roll pressing step S6c is a step of locally stretching the current collector 12, the substrate material, in the boundary regions 12d (see FIGS. 2 and 3) of the uncoated portions 12a with the active material layer 14. FIG. 6 is a schematic view illustrating the stepped roll pressing step S6c.

### Stepped Roll 50

As illustrated in FIG. 6, in a stepped roll 50 used in such a step S6c, the diameter of parts 51 thereof that come contact with the boundary regions 12d of the uncoated portions 12a with the active material layer 14 is locally larger than the diameter of other parts thereof (a part 53 that comes into contact with the active material layer 14 and parts 52 that come into contact with the uncoated portions 12a). In the embodiment shown in FIG. 6, the parts 51 that come into contact with the boundary regions 12d of the uncoated portions 12a with the active material layer 14 are uniformly larger in diameter circumferentially continuously. As illustrated in FIG. 4, the electrode sheet 10 is conveyed while being wrapped onto such a stepped roll 50 with a required tension. As a result, the boundary regions 12d between the active material layer 14 and the uncoated portions 12a are pressed onto the larger diameter parts 51 of the stepped roll 50. This allows the current collector 12 to be stretched locally at the boundary regions 12d of the uncoated portions 12a with the active material layer 14. Herein, the boundary regions 12d of the uncoated portions 12a with the active material layer 14 may each be a region at or near the boundary between the active material layer 14 and an uncoated portion 12a of the electrode sheet 10.

Herein, the boundary region 12d between the active material layer 14 and the uncoated portion 12a is defined as a region in which the current collector 12, the substrate material, is difficult to be stretched in the first pressing step S6a of press-stretching the uncoated portion 12a and in the second pressing step S6b of roll-pressing the active material layer 14. The boundary region 12d between the active material layer 14 and the uncoated portion 12a may be determined according to the specification of the electrode sheet 10 and the manufacturing process thereof. The width of the boundary region 12d between the active material layer 14 and the uncoated portion 12a may be, for example, about 0 mm to about 3 mm (for example, about 2 mm). The boundary region 12d between the active material layer 14 and the uncoated portion 12a may be provided with the protective layer 12c formed thereon, as illustrated in FIG. 3.

Such a roll-pressing step S6 includes the stepped roll pressing step S6c as described above. The stepped roll pressing step 6c involves conveying the electrode sheet 10 while pressing the electrode sheet 10 with the stepped roll 50, which includes the parts 51 that come into contact with the boundary regions 12d of the uncoated portions 12a with the active material layer 14 and are locally larger in diameter than other parts thereof that come into contact with other regions of the electrode sheet 10. Such a stepped roll pressing step S6c enables the current collector 12 to be stretched at the boundary regions 12d of the uncoated portions 12a with the active material layer 14 in the electrode sheet 10. Also, the process of stretching the uncoated portions 12a (the first pressing step S6a) and the process of roll-pressing the coated portion 12b of the electrode sheet 10 (the second pressing step S6b) are performed in addition to the above-described stepped roll pressing step S6c. This reduces the difference in elongation of the current collector 12 between the boundary regions 12d of the uncoated portions 12a with the active material layer 14 and other regions. As a result, it is possible to reduce wrinkles of the electrode sheet 10 that result from the difference in elongation rate of the current collector 12 between the boundary regions 12 of the uncoated portions 12a with the active material layer 14 and other regions of the uncoated portions 12a. In particular, it is possible to reduce the wrinkles that occur at the boundary regions 12d of the uncoated portions 12a with the active material layer 14.

### Electrode Sheet Manufacturing Apparatus 1

As illustrated in FIG. 4, an electrode sheet manufacturing apparatus 1 that embodies such an electrode sheet manufacturing method includes a roll-press unit 100 that roll-presses a strip-shaped electrode sheet 10. The roll-press unit 100 includes a conveyor device 102, a first pressing device 104, a second pressing device 106, and a stepped roll pressing device 108.

### Conveyor Device 102

The conveyor device 102 is a device that conveys the electrode sheet 10 along a predetermined conveyance passage W1. Although the details thereof are omitted, the conveyor device 102 may be a device that conveys the electrode sheet 10 along the conveyance passage W1. Although not shown in the drawings, the conveyor device 102 may include a mechanism for feeding the electrode sheet 10 along the conveyance passage W1, guide rolls that send out the electrode sheet 10 along the conveyance passage W1, a tension adjusting mechanism that applies a required tension to the electrode sheet 10, a mechanism for taking up the electrode sheet 10 that has been conveyed along the conveyance passage W1, and so forth.

### Stepped Roll Pressing Device 108

The stepped roll pressing device 108 is a device that is disposed in the conveyance passage W and presses a stepped roll 50 onto the electrode sheet 10. As illustrated in FIG. 6, the diameter of parts 51 of the stepped roll 50 that come into contact with the boundary regions 12d of the uncoated portion with the active material layer is locally larger than the diameter of the other parts of the stepped roll 50 that come into contact with other regions of the electrode sheet 10. As illustrated in FIG. 4, the roll-press unit 100 includes the first pressing device 104 that press-stretches the uncoated portions 12a of the electrode sheet 10 with the rubber rolls 30. The roll-press unit 100 further includes a second pressing device 106, which is disposed downstream of the first pressing device 104 and press-stretches the active material layer 14 of the electrode sheet 10 by roll-pressing. The arrow denoted by the reference character W1 in FIG. 4 represents the conveying direction of the conveyance passage W1.

Such a stepped roll pressing device 108 is provided with, as illustrated in FIG. 6, a stepped roll 50, in which the diameter of parts 51 that come into contact with the boundary regions 12d of the uncoated portions 12a with the active material layer 14 is locally larger than the diameter of other parts that come into contact with other regions of the electrode sheet 10. In the electrode sheet 10, the boundary regions 12d of the uncoated portions 12a with the active material layer 14 are pressed onto the parts 51 of the stepped roll 50 that have locally larger in diameter. For example, in the embodiment shown in FIG. 4, guide rolls 56 and 57 are disposed upstream and downstream of the stepped roll 50. The electrode sheet 10 is guided by guide rolls 56 and 57 so as to be conveyed while being wrapped onto the stepped roll 50. At this time, tension may be applied to the electrode sheet 10 by the guide rolls 56 and 57 so that the electrode sheet 10 is pressed onto the stepped roll 50. At this time, the locally raised parts 51 of the stepped roll 50 may be pressed onto the boundary regions 12d between the active material layer 14 and the uncoated portions 12a of the electrode sheet 10, as illustrated in FIG. 6.

Thus, the stepped roll pressing device 108 allows the electrode sheet 10 to be conveyed while the locally raised parts 51 of the stepped roll 50 are being pressed onto the boundary regions 12d between the active material layer 14 and the uncoated portions 12a of the electrode sheet 10. This allows the current collector 12 to be stretched locally in the boundary regions 12d of the uncoated portions 12a with the active material layer 14. Also, the process of stretching the uncoated portions 12a (the first pressing step S6a) and the process of roll-pressing the coated portion 12b of the electrode sheet 10 (the second pressing step S6b) are performed in addition to the above-described stepped roll pressing step S6c. This reduces the difference in elongation of the current collector 12 between the boundary regions 12d of the uncoated portions 12a with the active material layer 14 and other regions. As a result, it is possible to reduce wrinkles of the electrode sheet 10 that result from the difference in elongation rate of the current collector 12 between the boundary regions 12 of the uncoated portions 12a with the active material layer 14 and other regions of the uncoated portions 12a. In particular, it is possible to reduce the wrinkles that occur at the boundary regions 12d of the uncoated portions 12a with the active material layer 14.

Herein, the process of stretching the uncoated portions 12a may be, as described above, a process by EPS, for example. As described above, it is difficult for EPS to stretch the current collector 12 at the boundary regions 12d of the uncoated portions 12a with the active material layer 14. With the electrode sheet manufacturing method and the electrode sheet manufacturing apparatus 1 proposed herein, the current collector 12 is stretched by the stepped roll 50 at the boundary regions 12d of the uncoated portions 12a with the active material layer 14. From such a viewpoint, the process of locally stretching the current collector 12 at the boundary regions 12d of the uncoated portions 12a with the active material layer 14 with the stepped roll 50 is particularly advantageous when EPS is employed for the process of stretching the uncoated portions 12a. Note that the process of stretching the uncoated portions 12a is not limited to EPS, unless specifically stated otherwise.

In the electrode sheet manufacturing method proposed herein, the current collector 12 is locally stretched at the boundary regions 12d of the uncoated portions 12a with the active material layer 14 by the stepped roll 50. The process of locally stretching the current collector 12 at the boundary regions 12d may be performed together with the process of stretching the uncoated portions 12a and the process of roll-pressing the coated portion 12b of the electrode sheet 10. This reduces the difference in elongation of the current collector 12 between the boundary regions 12d of the uncoated portions 12a with the active material layer 14 and other regions. The electrode sheet manufacturing method proposed herein may be incorporated as part of a method of manufacturing a battery.

As illustrated in FIG. 4, according to the discovery by the present inventors, the process of stretching the uncoated portions 12a (i.e., the first pressing step S6a) may be performed prior to the process of stretching the coated portion 12b (i.e., the second pressing step S6b). When the coated portion 12a has been stretched before the process of stretching the coated portions 12b (the second pressing step S6b), wrinkles are less likely to form at the time of stretching the coated portion 12b. The process of stretching the uncoated portions 12a (i.e., the first pressing step S6a) may be processed by EPS, as described above.

In the embodiment shown in FIG. 4, the stepped roll pressing step S6c is performed after the process of stretching the coated portion 12b (i.e., the second pressing step S6b). As illustrated in FIG. 4, the electrode sheet manufacturing apparatus 1 may include the first pressing device 104, the second pressing device 106, and the stepped roll pressing device 108 that are disposed in that order along the conveying direction of the conveyance passage W1.

In this case, the uncoated portions 12a are stretched first. Then, the coated portion 12b is stretched, and thereafter, the current collector 12 is locally stretched by the stepped roll pressing step S6c at the boundary regions 12d of uncoated portions 12a with the active material layer 14. In this case, after the uncoated portions 12a are stretched and further the coated portion 12b is stretched, the strain that locally remains in the boundary regions 12d of the uncoated portions 12a with the active material layer 14 is corrected by the stepped roll pressing step S6c. As a result, wrinkles are reduced across the electrode sheet 10 as a whole.

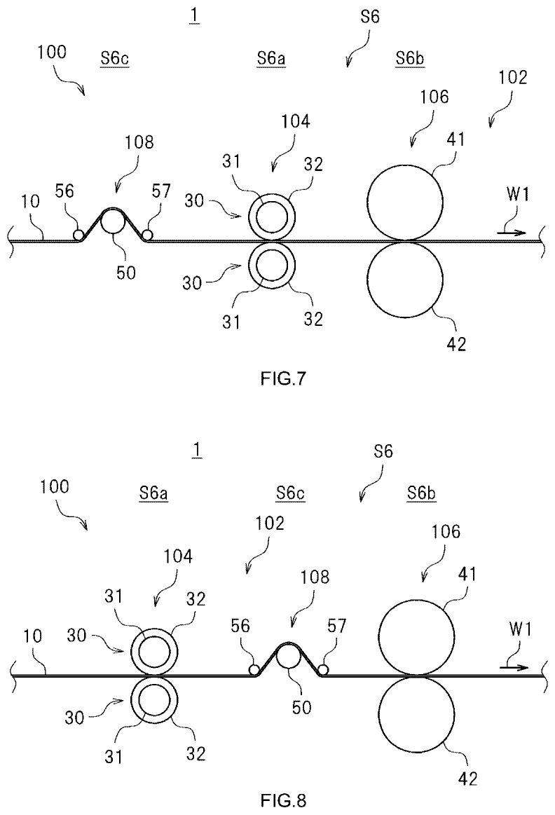

FIG. 7 is a schematic view illustrating another embodiment of the electrode sheet manufacturing method. In the embodiment shown in FIG. 7, the stepped roll pressing step S6c is performed before the process of further stretching the uncoated portions 12a (i.e., the first pressing step S6a). As illustrated in FIG. 7, the electrode sheet manufacturing apparatus 1 may include the stepped roll pressing device 108, the first pressing device 104, and the second pressing device 106 that are disposed in that order along the conveying direction of the conveyance passage W1.

In this case, first, the current collector 12 is stretched by the stepped roll pressing step S6c locally at the boundary regions 12d of uncoated portions 12a with the active material layer 14. Next, the uncoated portions 12a are stretched, and further, the coated portion 12b is stretched. In this case, the current collector 12 is stretched with the current collector 12 having been stretched locally at the boundary regions 12d of the uncoated portions 12a with the active material layer 14, and further, the coated portion 12b is stretched. Thus, before the process of stretching the uncoated portions 12a and the coated portion 12b, the current collector 12 has been locally stretched at the boundary regions 12d of the uncoated portions 12a with the active material layer 14. As a result, when the uncoated portions 12a and the coated portion 12b are stretched, wrinkles are reduced across the electrode sheet 10 as a whole.

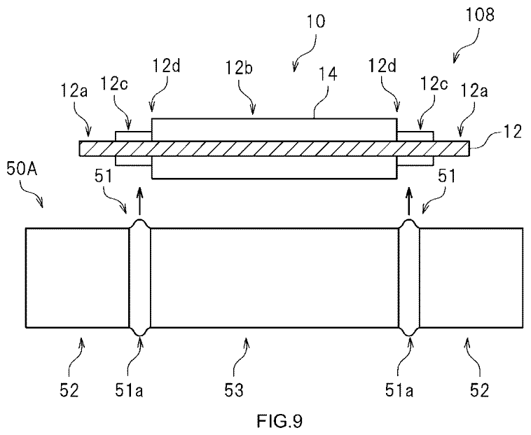

FIG. 8 is a schematic view illustrating another embodiment of the manufacturing method of an electrode sheet 10. In the embodiment shown in FIG. 8, the stepped roll pressing step S6c is performed after the first pressing step S6a but before the second pressing step S6b. As illustrated in FIG. 8, the electrode sheet manufacturing apparatus 1 may include the first pressing device 104, the stepped roll pressing device 108, and the second pressing device 106 that are disposed in that order along the conveying direction of the conveyance passage W1.

In this case, after the uncoated portions 12a have been stretched by the first pressing step S6a, the current collector 12 is locally stretched by the stepped roll pressing step S6c at the boundary regions 12d of uncoated portions 12a with the active material layer 14. Then, the coated portion 12b is further stretched by the second pressing step S6b. In this case, after the uncoated portions 12a have been stretched by the process of stretching the uncoated portions 12a, the current collector 12 is locally stretched at the boundary regions 12d of uncoated portions 12a with the active material layer 14. Thereafter, the coated portion 12b is stretched. In this case, the electrode sheet 10 is stretched in a step-by-step manner from outside, and wrinkles are reduced across the electrode sheet 10 as a whole.

As described above, the order of the process of locally stretching the current collector 12 at the boundary regions 12d, the roll-pressing of the electrode sheet 10, and the process of stretching the uncoated portions 12a may be changed over as appropriate.

For example, in FIG. 4, etc., the first pressing step S6a (the step of pressing the uncoated portions 12a) is performed prior to the second pressing step S6b (the step of roll-pressing the active material layer 14), but such a sequential order is not limited thereto either. The first pressing step S6a may be performed either (i) before the second pressing step S6b or (ii) after the second pressing step S6b. Alternatively, the first pressing step S6a may be performed (iii) both before and after the second pressing step S6b. The above-described stepped roll pressing step S6c may be performed at any desired position in (i) to (iii) above, such as upstream of or downstream of the first pressing step S6a and upstream of or downstream of the second pressing step S6b.

### Stepped Roll 50A

FIG. 9 is a schematic view illustrating a stepped roll 50A. The stepped roll 50A is another form of the stepped roll 50 that is used in the stepped roll pressing step S6c. In the example shown in FIG. 9, the stepped roll 50A includes parts 51 coming into contact with the boundary regions 12d of the uncoated portions 12a with the active material layer 14, and each of the parts 51 is raised higher toward its middle portion 51a with respect to the axial direction of the stepped roll 50A. More specifically, in the example shown in FIG. 9, the middle portion is raised so as to be symmetrical like a normal distribution with respect to the axial direction of the stepped roll 50A. Thus, the parts 51 coming into contact with the boundary regions 12d of the uncoated portions 12a with the active material layer 14 may each have a shape that is raised higher toward its widthwise middle portion. The shape that is raised higher toward the middle portion with respect to the axial direction allows the stepped roll 50A to eliminate abrupt surface level differences such as steps. As a result, it is possible to prevent wrinkles from occurring in the electrode sheet 10 because of the parts 51 of the stepped roll 50A that are locally larger in diameter.

In this case, the parts 51 are not limited to having a shape such that its middle portion is raised so as to be symmetrical such as a normal distribution, but may have a shape such as to be raised in a circular arc shape. The center of the locally larger diameter part 51 of the stepped roll 50A may match the widthwise center of the portion of the current collector 12 in which stretching is expected to be insufficient in the first pressing step S6a and the second pressing step S6b. From such a viewpoint, the gap along the axial direction between the parts 51 of the stepped roll 50A, each having a locally larger diameter, may be determined according to, for example, the width of the coated portion 12b of the electrode sheet 10 that is to be processed. In addition, the electrode sheet 10 may be conveyed so that the widthwise center of the locally larger diameter part 51 of the stepped roll 50A matches the portion of the current collector 12 in which the stretching is expected to be insufficient. In this respect, it is also possible that the conveyor device 102 may incorporate, for example, a position adjusting mechanism for adjusting the position of the electrode sheet 10 relative to the stepped roll 50.

Various embodiments of the invention have been described hereinabove according to the present disclosure. Unless specifically stated otherwise, the embodiments described herein do not limit the scope of the present invention. It should be noted that various other modifications and alterations may be possible in the embodiments of the invention disclosed herein. In addition, the features, structures, or steps described herein may be omitted as appropriate, or may be combined in any suitable combinations, unless specifically stated otherwise.

As has been described above, the present description contains the disclosure as set forth in the following items.

### Item 1

An electrode sheet manufacturing apparatus for manufacturing an electrode sheet, the electrode sheet including a current collector made of an oblong metal foil, an unformed portion defined along a longitudinal axis of the current collector at a predetermined widthwise position in the current collector, and an active material layer formed on a portion of the current collector other than the uncoated portion, the apparatus including:
a roll-press unit roll-pressing the electrode sheet, wherein:
the roll-press unit includes:
   a conveyor device conveying the electrode sheet along a predetermined conveyance passage; and
   a stepped roll pressing device disposed in the conveyance passage and pressing a stepped roll onto the electrode sheet; and
the stepped roll has a larger diameter locally at a part coming into contact with a boundary region of the unformed portion with the active material layer than other parts of the stepped roll coming into contact with other regions of the electrode sheet.

### Item 2

The electrode sheet manufacturing apparatus according to item 1, wherein:
the roll-press unit further comprises:
   a first pressing device disposed in the conveyance passage and press-stretching the unformed portion of the electrode sheet by a rubber roll; and
   a second pressing device disposed downstream of the first pressing device and press-stretches the active material layer of the electrode sheet by roll-pressing; and
the stepped roll pressing device is disposed before the first pressing device in the conveyance passage.

### Item 3

The electrode sheet manufacturing apparatus according to item 1, wherein:
the roll-press unit further comprises:
   a first pressing device disposed in the conveyance passage and press-stretching the unformed portion of the electrode sheet by a rubber roll; and
   a second pressing device disposed downstream of the first pressing device and press-stretches the active material layer of the electrode sheet by roll-pressing; and
the stepped roll pressing device is disposed downstream of the first pressing device and upstream of the second pressing device in the conveyance passage.

### Item 4

The electrode sheet manufacturing apparatus according to item 1, wherein:
the roll-press unit further comprises:
   a first pressing device disposed in the conveyance passage and press-stretching the unformed portion of the electrode sheet by a rubber roll; and
   a second pressing device disposed downstream of the first pressing device and press-stretches the active material layer of the electrode sheet by roll-pressing; and
the stepped roll pressing device is disposed downstream of the second pressing device in the conveyance passage.

### Item 5

The electrode sheet manufacturing apparatus according to item 1, wherein the part of the stepped roll coming into contact with the boundary region of the unformed portion with the active material layer is raised higher toward its middle portion with respect to an axial direction of the stepped roll.

### Item 6

A method of manufacturing an electrode sheet, the electrode sheet including a current collector made of an oblong metal foil, an unformed portion defined along a longitudinal axis of the current collector at a predetermined widthwise position in the current collector, and an active material layer formed on a portion of the current collector other than the uncoated portion, the method including:
a stepped roll pressing step of conveying the electrode sheet while pressing the electrode sheet with a stepped roll having a larger diameter locally at a part coming into contact with a boundary region of the uncoated portion with the active material layer than other parts of the stepped roll coming into contact with other regions of the electrode sheet.

### Item 7

The electrode sheet manufacturing method according to item 6, wherein:
a first pressing step of press-stretching the unformed portion of the electrode sheet by a rubber roll while conveying the electrode sheet along a predetermined conveyance passage; and
a second pressing step of roll-pressing the active material layer of the electrode sheet after the first pressing step in the conveyance passage; and wherein
the stepped roll pressing step is performed before the first pressing step.

### Item 8

The electrode sheet manufacturing method according to item 6, wherein:
a first pressing step of press-stretching the unformed portion of the electrode sheet by a rubber roll while conveying the electrode sheet along a predetermined conveyance passage; and
a second pressing step of press-stretching the active material layer of the electrode sheet by roll-pressing after the first pressing step in the conveyance passage; and wherein
the stepped roll pressing step is performed after the first pressing step and before the first pressing step.

### Item 9

The electrode sheet manufacturing method according to item 6, wherein:
a first pressing step of press-stretching the unformed portion of the electrode sheet by a rubber roll while conveying the electrode sheet along a predetermined conveyance passage; and
a second pressing step of roll-pressing the active material layer of the electrode sheet after the first pressing step in the conveyance passage; and wherein
the stepped roll pressing step is performed after the second pressing step.

### Item 10

The electrode sheet manufacturing method according to item 6, wherein the part of the stepped roll coming into contact with the boundary region of the unformed portion with the active material layer is raised higher toward its middle portion with respect to an axial direction of the stepped roll.

### Item 11

A method of manufacturing a battery, the method including a method according to any one of items 6 through 10.

What is claimed is:

1. An electrode sheet manufacturing apparatus for manufacturing an electrode sheet, the electrode sheet comprising a current collector made of an oblong metal foil, an unformed portion defined along a longitudinal axis of the current collector at a predetermined widthwise position in the current collector, and an active material layer formed on a portion of the current collector other than the unformed portion, the apparatus comprising:
a roll-press unit roll-pressing the electrode sheet, wherein:
the roll-press unit includes:
a conveyor device conveying the electrode sheet along a predetermined conveyance passage; and
a stepped roll pressing device disposed in the conveyance passage and pressing a stepped roll onto the electrode sheet; and
the stepped roll has a larger diameter locally at a part coming into contact with a boundary region of the unformed portion with the active material layer than other parts of the stepped roll coming into contact with other regions of the electrode sheet.

2. The electrode sheet manufacturing apparatus according to claim 1, wherein:
the roll-press unit further comprises:
a first pressing device disposed in the conveyance passage and press-stretching the unformed portion of the electrode sheet by a rubber roll; and
a second pressing device disposed downstream of the first pressing device in the conveyance passage and press-stretching the active material layer of the electrode sheet by roll-pressing; and
the stepped roll pressing device is disposed before the first pressing device in the conveyance passage.

3. The electrode sheet manufacturing apparatus according to claim 1, wherein:
the roll-press unit further comprises:
a first pressing device disposed in the conveyance passage and press-stretching the unformed portion of the electrode sheet by a rubber roll; and
a second pressing device disposed downstream of the first pressing device in the conveyance passage and press-stretching the active material layer of the electrode sheet by roll-pressing; and
the stepped roll pressing device is disposed downstream of the first pressing device and upstream of the second pressing device in the conveyance passage.

4. The electrode sheet manufacturing apparatus according to claim 1, wherein:
the roll-press unit further comprises:
a first pressing device disposed in the conveyance passage and press-stretching the unformed portion of the electrode sheet by a rubber roll; and
a second pressing device disposed downstream of the first pressing device in the conveyance passage and press-stretching the active material layer of the electrode sheet by roll-pressing; and
the stepped roll pressing device is disposed downstream of the second pressing device in the conveyance passage.

5. The electrode sheet manufacturing apparatus according to claim 1, wherein the part of the stepped roll coming into contact with the boundary region of the unformed portion with the active material layer is raised higher toward its middle portion with respect to an axial direction of the stepped roll.

6. A method of manufacturing an electrode sheet, the electrode sheet including a current collector made of an oblong metal foil, an unformed portion defined along a longitudinal axis of the current collector at a predetermined widthwise position in the current collector, and an active material layer formed on a portion of the current collector other than the uncoated portion, the method comprising:
a stepped roll pressing step of conveying the electrode sheet while pressing the electrode sheet with a stepped roll having a larger diameter locally at a part coming into contact with a boundary region of the uncoated portion with the active material layer than other parts of the stepped roll coming into contact with other regions of the electrode sheet.

7. The electrode sheet manufacturing method according to claim 6, further comprising:
a first pressing step of press-stretching the unformed portion of the electrode sheet by a rubber roll while conveying the electrode sheet along a predetermined conveyance passage; and
a second pressing step of roll-pressing the active material layer of the electrode sheet after the first pressing step in the conveyance passage; and wherein
the stepped roll pressing step is performed before the first pressing step.

8. The electrode sheet manufacturing method according to claim 6, further comprising:
a first pressing step of press-stretching the unformed portion of the electrode sheet by a rubber roll while conveying the electrode sheet along a predetermined conveyance passage; and
a second pressing step of press-stretching the active material layer of the electrode sheet by roll-pressing after the first pressing step in the conveyance passage; and wherein
the stepped roll pressing step is performed after the first pressing step and before the first pressing step.

9. The electrode sheet manufacturing method according to claim 6, further comprising:
a first pressing step of press-stretching the unformed portion of the electrode sheet by a rubber roll while conveying the electrode sheet along a predetermined conveyance passage; and
a second pressing step of roll-pressing the active material layer of the electrode sheet after the first pressing step in the conveyance passage; and wherein
the stepped roll pressing step is performed after the second pressing step.

10. The electrode sheet manufacturing method according to claim 6, wherein the part of the stepped roll coming into contact with the boundary region of the unformed portion with the active material layer is raised higher toward its middle portion with respect to an axial direction of the stepped roll.

11. A method of manufacturing a battery, the method comprising a method according to claim 6.

12. A method of manufacturing a battery, the method comprising a method according to claim 7.

13. A method of manufacturing a battery, the method comprising a method according to claim 8.

14. A method of manufacturing a battery, the method comprising a method according to claim 9.

15. A method of manufacturing a battery, the method comprising a method according to claim 10.
